(19) United States
(12) Patent Application Publication
(10) Pub. No.: US 2026/0128048 A1
(43) Pub. Date: May 7, 2026

(54) VOICE ENHANCEMENT METHOD AND APPARATUS, ELECTRONIC DEVICE, AND STORAGE MEDIUM

(71) Applicant: VIVO MOBILE COMMUNICATION CO., LTD., Guangdong (CN)

(72) Inventors: Hongbo YANG, Guangdong (CN); Qi HAO, Guangdong (CN)

(21) Appl. No.: 19/438,757

(22) Filed: Jan. 2, 2026

Related U.S. Application Data
(63) Continuation of application No. PCT/CN2024/103189, filed on Jul. 2, 2024.

(30) Foreign Application Priority Data
Jul. 6, 2023 (CN) 202310833021.0

(51) Int. Cl. G10L 19/06; G10L 19/00; G10L 19/02; G10L 25/90

(52) U.S. Cl. CPC G10L 19/06; G10L 19/0204; G10L 25/90; G10L 2019/0016

(57) ABSTRACT

This application discloses a voice enhancement method and apparatus, an electronic device, and a storage medium. The method includes: extracting first excitation information and first envelope information from a first frequency domain signal corresponding to a first voice signal, where the first voice signal includes a noise signal and a first clean voice signal; performing optimal excitation codebook matching on the first excitation information to obtain second excitation information; performing optimal envelope codebook matching on the first envelope information to obtain second envelope information; synthesizing target spectral information based on the first excitation information, the second excitation information, and the second envelope information; and performing voice enhancement processing on the first voice signal based on the target spectral information.

### CROSS-REFERENCE TO RELATED APPLICATIONS

This application is a Bypass continuation application of PCT International Application No. PCT/CN2024/103189 filed on Jul. 2, 2024, which claims priority to Chinese Patent Application No. 202310833021.0, filed in China on Jul. 6, 2023, which are incorporated herein by reference in their entireties.

### TECHNICAL FIELD

This application relates to the field of audio noise reduction technologies, and specifically, to a voice enhancement method and apparatus, an electronic device, and a storage medium.

### BACKGROUND

Currently, when an electronic device performs noise reduction processing on voice signals of the electronic device through Wiener filtering and statistical models, the electronic device can perform noise reduction processing on the voice signals based on a prior signal-to-noise ratio, to obtain noise-free voice signals. Usually, an accurate prior signal-to-noise ratio needs to be obtained based on a power spectrum of a clean voice signal. However, in practical situations, the electronic device can obtain only noisy voice signals.

Therefore, in related technologies, the electronic device may estimate a prior signal-to-noise ratio by using a decision-directed method, that is, the electronic device may estimate the prior signal-to-noise ratio based on a posterior signal-to-noise ratio.

However, in a process of obtaining the posterior signal-to-noise ratio, in a case that power of a clean voice signal is close to power of a noise signal, the electronic device cannot obtain an accurate posterior signal-to-noise ratio. This leads to a significant error in a prior signal-to-noise ratio estimated by the electronic device based on the posterior signal-to-noise ratio. Consequently, accuracy of the prior signal-to-noise ratio determined by the electronic device is low, leading to a poor noise reduction effect for a voice signal.

### SUMMARY

Embodiments of this application aim to provide a voice enhancement method and apparatus, an electronic device, and a storage medium.

According to a first aspect, an embodiment of this application provides a voice enhancement method. The method for determining spectral information includes: extracting first excitation information and first envelope information from a first frequency domain signal corresponding to a first voice signal, where the first voice signal includes a noise signal and a first clean voice signal; performing optimal excitation codebook matching on the first excitation information to obtain second excitation information; performing optimal envelope codebook matching on the first envelope information to obtain second envelope information; synthesizing target spectral information based on the first excitation information, the second excitation information, and the second envelope information; and performing voice enhancement processing on the first voice signal based on the target spectral information.

According to a second aspect, an embodiment of this application provides a voice enhancement apparatus. The voice enhancement apparatus includes: an extraction module, a matching module, a synthesis module, and a processing module. The extraction module is configured to extract first excitation information and first envelope information from a first frequency domain signal corresponding to a first voice signal, where the first voice signal includes a noise signal and a first clean voice signal. The matching module is configured to: perform optimal excitation codebook matching on the first excitation information extracted by the extraction module to obtain second excitation information, and perform optimal envelope codebook matching on the first envelope information extracted by the extraction module to obtain second envelope information. The synthesis module is configured to synthesize target spectral information based on the first excitation information, the second excitation information, and the second envelope information. The processing module is configured to perform voice enhancement processing on the first voice signal based on the target spectral information.

According to a third aspect, an embodiment of this application provides an electronic device. The electronic device includes a processor and a memory, the memory stores a program or an instruction executable on the processor, and the program or the instruction is executed by the processor to implement the steps of the method according to the first aspect.

According to a fourth aspect, an embodiment of this application provides a readable storage medium. The readable storage medium stores a program or an instruction, and the program or the instruction is executed by a processor to implement the steps of the method according to the first aspect.

According to a fifth aspect, an embodiment of this application provides a chip. The chip includes a processor and a communication interface, the communication interface is coupled to the processor, and the processor is configured to run a program or an instruction to implement the method according to the first aspect.

According to a sixth aspect, an embodiment of this application provides a computer program product. The program product is stored in a storage medium, and the program product is executed by at least one processor to implement the method according to the first aspect.

### BRIEF DESCRIPTION OF DRAWINGS

FIG. 1 is a first flowchart of a voice enhancement method according to an embodiment of this application;

FIG. 2 is a second flowchart of a voice enhancement method according to an embodiment of this application;

FIG. 3 is a third flowchart of a voice enhancement method according to an embodiment of this application;

FIG. 4 is a first structural diagram of a deep neural network according to an embodiment of this application;

FIG. 5 is a second structural diagram of a deep neural network according to an embodiment of this application;

FIG. 6 is a third structural diagram of a deep neural network according to an embodiment of this application;

FIG. 7 is a schematic structural diagram of a voice enhancement apparatus according to an embodiment of this application;

FIG. 8 is a first schematic diagram of a hardware structure of an electronic device according to an embodiment of this application; and

FIG. 9 is a second schematic diagram of a hardware structure of an electronic device according to an embodiment of this application.

### DESCRIPTION OF EMBODIMENTS

The following clearly describes the technical solutions in the embodiments of this application with reference to the accompanying drawings in the embodiments of this application. Clearly, the described embodiments are some but not all of the embodiments of this application.

In the specification and claims of this application, the terms such as “first” and “second” are used for distinguishing similar objects, and are not necessarily used to describe a particular order or sequence. It should be understood that, the terms termed in such a way are interchangeable in proper circumstances, so that the embodiments of this application can be implemented in an order other than the order illustrated or described herein. Objects classified by “first”, “second”, and the like are usually of a same type, and the number of objects is not limited. For example, there may be one or more first objects. In addition, in this specification and the claims, “and/or” indicates at least one of connected objects, and a character “/” generally indicates an “or” relationship between associated objects.

With reference to the accompanying drawings, a voice enhancement method and apparatus, an electronic device, and a storage medium provided in the embodiments of this application are described in detail by using specific embodiments and application scenarios thereof.

The voice enhancement method and apparatus, the electronic device, and the storage medium provided in the embodiments of this application may be applied to a voice call scenario in which a mobile electronic device such as a sound box, a conference terminal, or a headset is used to make a call.

Currently, when a user performs a voice call by using an electronic device, to ensure quality of the voice call, the electronic device may perform noise reduction processing on a voice signal in the voice call, so that the electronic device may receive a voice signal with good call quality.

Usually, when the electronic device performs voice noise reduction, the electronic device may perform noise reduction processing on a noisy voice signal through Wiener filtering and statistical models, which is briefly referred to as a conventional noise reduction method. The method is widely applied due to simplicity, effectiveness, ease of real-time computation, and low engineering computational load.

Specifically, it is assumed that a noisy voice signal received by the electronic device through a microphone is: x(t)=s(t)+n(t).

s(t) represents an unknown clean voice signal, and n(t) represents a random noise signal. The electronic device may input the noisy voice signal to framing, windowing, and fast Fourier transform (FFT) algorithms, so that the electronic device may obtain a frequency domain signal corresponding to the noisy voice signal. The frequency domain signal is: X(f, k)=FFT[x(t)]=s(f, k)+n(f, k).

k represents a frame number, and f represents a frequency.

After the electronic device obtains the frequency domain signal corresponding to the noisy voice signal, the electronic device may define a posterior signal-to-noise ratio

$$γ ( f , k ) = \frac{{P}_{xx} ( f , k )}{{P}_{nn} ( f , k )}$$

and define a prior signal-to-noise ratio

$$ξ ( f , k ) = \frac{{P}_{ss} ( f , k )}{{P}_{nn} ( f , k )} \cdot {P}_{nn} ( f , k )$$

represents an estimated value of a noise spectrum corresponding to the noisy voice signal, Pₓₓ(f,k) represents a spectrum (known) of the noisy voice signal, and Pₛₛ(f,k) represents a clean voice power spectrum (unknown).

Generally, a method for estimating a noise power spectrum is designed in the following form. The noisy voice signal is expressed in a complex form of amplitude and phase:

$$X ( f , k ) = r \cdot exp ( j \cdot θ ) .$$

The spectrum of the noise signal is expressed in a complex form of amplitude and phase: N(f, k)=n·exp(j·δ).

Given an observation of the noisy voice signal X(f, k), according to Bayes' theorem, a minimum mean square error (MMSE) estimation of the noise power spectrum may be derived from an expectation in the following Formula 1.

$$E \{ {N}^{2} \vert X \} = \frac{{\int }_{0}^{∞} {\int }_{0}^{2 π} {n}^{2} * f ( X \vert n , δ ) * f ( n , δ ) d δ dn}{{\int }_{0}^{∞} {\int }_{0}^{2 π} f ( X \vert n , δ ) * f ( n , δ ) d δ dn} \qquad ( Formula 1 )$$

f(X|n,δ) represents a conditional probability of the clean voice signal, and f(n,δ) represents a conditional probability of the noise signal.

Assuming that the clean voice signal and the noise signal follow respective independent complex Gaussian distributions, the conditional probabilities in the numerator and the denominator may be expressed using the following Formula 2 and Formula 3:

$$f ( X \vert n , δ ) = \frac{1}{π \cdot {P}_{ss}} exp ( \frac{2 nr cos ( δ - θ ) - {r}^{2} - {n}^{2}}{{P}_{ss}} ) \qquad ( Formula 2 )$$

$$f ( n , δ ) = \frac{n}{π \cdot {P}_{nn}} exp ( - \frac{{n}^{2}}{{P}_{nn}} ) \qquad ( Formula 3 )$$

Then, the electronic device transforms the estimated value of the noise spectrum into a form of prior signal-to-noise ratio through iterative update, which may be specifically implemented through the following Formula 4.

$$( Formula 4 )$$

$${P}_{nn} ( f , k ) = \frac{ξ ( f , k - 1 )}{1 + ξ ( f , k - 1 )} \cdot {P}_{nn} ( f , k - 1 ) + {( \frac{1}{1 + ξ ( f , k - 1 )} )}^{2} \cdot {P}_{xx} ( f , k )$$

After calculating the noise power spectrum, the electronic device may use the noise power spectrum to update a prior signal-to-noise ratio of a current frame, to further obtain a noise reduction gain G based on a statistical model. The noise reduction gain G usually has the following two forms:
Form 1: a noise reduction gain in a form of Wiener filtering G_{winner}(f, k). The noise reduction gain

$${G}_{winner} ( f , k ) = \frac{{P}_{ss}}{{P}_{xx}} = \frac{{P}_{ss}}{{P}_{ss} + {P}_{nn}} = \frac{ξ ( f , k )}{ξ ( f , k ) + 1} ,$$

where ξ(f, k) represents the prior signal-to-noise ratio.
Form 2: a noise reduction gain in a form of log-amplitude spectrum MMSE estimation. The noise reduction gain

$${G}_{MMSE - LSA} ( f , k ) = \frac{ξ ( f , k )}{ξ ( f , k ) + 1} exp ( \frac{1}{2} {\int }_{vk}^{∞} \frac{{e}^{- t}}{t} dt ) ,$$

$$where$$

$$vk = \frac{ξ ( f , k )}{ξ ( f , k ) + 1} γ ( f , k ) .$$

The electronic device performs a multiplication operation between the noise reduction gain and the frequency domain signal corresponding to the noisy voice signal, and then performs inverse fast Fourier transform (IFFT) to obtain a noise-reduced voice signal, which may be specifically implemented through the following Formula 5.

$$\hat{x} ( t ) = iFFT [ G ( f ) * X ( f ) ] \qquad ( Formula 5 )$$

Generally, the electronic device may perform noise reduction processing on a voice signal by using the foregoing conventional noise reduction method, to obtain a noise-free voice signal. Specifically, it can be learned from the foregoing conventional noise reduction method that the prior signal-to-noise ratio ξ(f, k) plays a key role in both estimation of the noise power spectrum and estimation of the noise reduction gain. In other words, the prior signal-to-noise ratio determines a noise reduction effect. An accurate prior signal-to-noise ratio can be obtained only based on the power spectrum of the clean voice signal. However, in an actual scenario, the electronic device can usually obtain only a noisy voice signal. Therefore, to obtain an accurate prior signal-to-noise ratio, the electronic device can use a decision-directed approach. An idea of this approach is to first calculate a posterior signal-to-noise ratio, use the posterior signal-to-noise ratio as an estimated value of the prior signal-to-noise ratio, and perform smoothing calculation on the estimated value of the prior signal-to-noise ratio and a prior signal-to-noise ratio of a previous frame of audio segment to obtain a prior signal-to-noise ratio of a current frame of audio segment, which may be specifically implemented through the following Formula 6.

$$ξ ( f , k ) = α * ξ ( f , k - 1 ) + ( 1 - α ) * max ( 0 , γ ( f , k ) - 1 ) \qquad ( Formula 6 )$$

γ(f, k)−1 represents the posterior signal-to-noise ratio, ξ(f, k−1) represents the prior signal-to-noise ratio of the previous frame, and a represents a smoothing coefficient.

It should be noted that, the previous frame and the current frame are obtained by the electronic device by performing framing and windowing on the noisy voice signal when the electronic device transforms the noisy voice signal into the frequency domain signal. For example, the electronic device may segment the noisy voice signal into 10 audio segments. In this case, any audio segment in the 10 audio segments is one frame of audio segment.

However, in the foregoing method, measurement of the posterior signal-to-noise ratio is accurate in the case of a high signal-to-noise ratio (voice power is greater than noise power). As the signal-to-noise ratio gradually decreases (the voice power is close to the noise power), an estimation error of the signal-to-noise ratio increases. When the voice power is less than the noise power, the posterior signal-to-noise ratio is zero, and the electronic device no longer has a measurement capability. Moreover, due to existence of the smoothing coefficient α, slow iterative update facilitates stability in estimation of the prior signal-to-noise ratio, but leads to a delay, while rapid iterative update causes instability in estimation of the prior signal-to-noise ratio, resulting in fluctuation of the noise reduction gain and “musical noise” in subjective listening experience. Due to the foregoing defects, the conventional noise reduction method can obtain an accurate noise reduction gain only in a scenario with a high signal-to-noise ratio. In a scenario with a low signal-to-noise ratio, an error in the estimated signal-to-noise ratio causes problems such as voice degradation and an insufficient noise reduction gain, making it difficult to meet an application requirement.

However, according to a voice enhancement method and apparatus, an electronic device, and a storage medium provided in the embodiments of this application, an electronic device may perform optimal excitation codebook matching on first excitation information, and perform optimal envelope codebook matching on first envelope information. In this case, the electronic device may obtain second excitation information and second envelope information that correspond to a first clean voice signal, and can further obtain target spectral information by using the first excitation information, the second excitation information, and the second envelope information, so that the electronic device may obtain, based on the target spectral information, an accurate prior signal-to-noise ratio corresponding to the first clean voice signal, and then the electronic device may perform voice enhancement processing based on the accurate prior signal-to-noise ratio. This improves a noise reduction effect of the electronic device for voice noise reduction. It may be understood that, because a posterior signal-to-noise ratio is not involved in embodiments of this application, regardless of whether the electronic device is in a scenario with a high signal-to-noise ratio or in a scenario with a low signal-to-noise ratio, the electronic device may obtain the accurate prior signal-to-noise ratio based on target spectral information of a clean voice signal. In this way, the electronic device may obtain an accurate noise reduction gain based on the accurate prior signal-to-noise ratio, and further obtain a voice signal with a good noise reduction effect.

The voice enhancement method provided in an embodiment of this application may be performed by the voice enhancement apparatus. The voice enhancement apparatus may be an electronic device, or a functional module in the electronic device. The following uses the electronic device as an example to describe the technical solutions provided in this embodiment of this application.

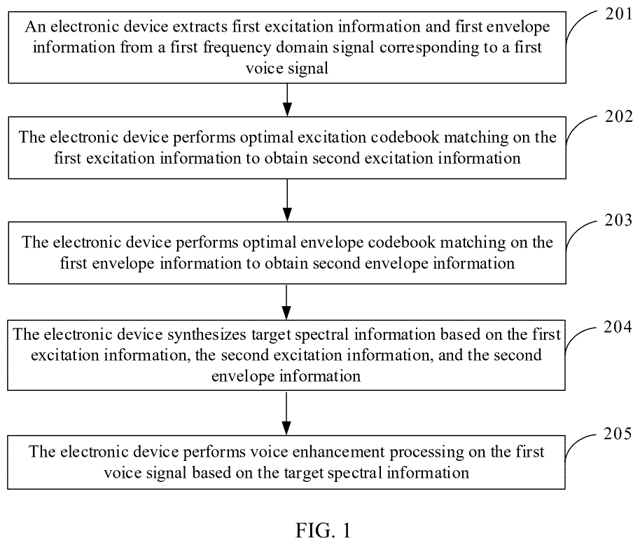

An embodiment of this application provides a voice enhancement method. FIG. 1 is a flowchart of a voice enhancement method according to an embodiment of this application. As shown in FIG. 1, the voice enhancement method provided in this embodiment of this application may include the following step 201 to step 205.
Step 201: An electronic device extracts first excitation information and first envelope information from a first frequency domain signal corresponding to a first voice signal.

In this embodiment of this application, the first voice signal includes a noise signal and a first clean voice signal.

For example, the first voice signal may be a voice signal captured by the electronic device through a microphone. Generally, such a temporally continuous signal is usually a time domain signal.

Optionally, in this embodiment of this application, the first frequency domain signal may be all frequency domain signals corresponding to the first voice signal, or a part of frequency domain signals corresponding to the first voice signal.

In this embodiment of this application, after the electronic device obtains the first voice signal, the electronic device may obtain, by using a short-time Fourier transform (STFT) algorithm, the first frequency domain signal corresponding to the first voice signal.

For example, after the electronic device obtains the first voice signal, the electronic device may perform framing processing, windowing processing, and FFT, that is, the STFT, on the first voice signal, to obtain a frequency domain representation of the first voice signal.

For another example, it is assumed that a sampling frequency of the first voice signal is 16 kHz, a frame length is set to 32 ms, an overlap is set to 8 ms, a window function is set to a Hanning window, and an FFT length is set to 512 points. The electronic device may obtain a frequency domain representation of the first voice signal by using the foregoing settings of the parameters and the STFT algorithm.

For another example, after obtaining the complete first voice signal, the electronic device may obtain, by using the STFT algorithm, a first frequency domain signal corresponding to the complete first voice signal. Alternatively, in a process in which the electronic device receives the first voice signal, the electronic device may obtain, in real time by using the STFT algorithm, a part of the first frequency domain signal corresponding to a part of the first voice signal. In this case, when the electronic device ends receiving the first voice information, the electronic device may add a part of the first frequency domain signal corresponding to each part of the first voice signal, to obtain the first frequency domain signal.

In some embodiments of this application, the first frequency domain signal includes frequency domain signals corresponding to L audio frames, where L is a positive integer.

In some embodiments of this application, when transforming a time domain signal into a frequency domain signal by using the STFT algorithm, the electronic device performs segmentation processing on the time domain signal, that is, performs framing processing on the time domain signal, to obtain a plurality of audio segments of the time domain signal. Then, windowing processing and FFT may be performed to obtain a frequency domain signal corresponding to each audio segment.

Optionally, in this embodiment of this application, when transforming the first voice signal into the first frequency domain signal, the electronic device performs framing processing on the first voice signal, to obtain L audio frames corresponding to L audio segments of the first voice signal. Then, windowing processing and FFT are performed to obtain a frequency domain signal corresponding to each audio frame. Finally, superposition processing is performed on the frequency domain signals corresponding to the L audio frames, to obtain the first frequency domain signal.
Step 202: The electronic device performs optimal excitation codebook matching on the first excitation information to obtain second excitation information.

In this embodiment of this application, the second excitation information is excitation information corresponding to a clean voice signal in the first voice signal.

In this embodiment of this application, the electronic device may perform optimal excitation codebook matching on the first excitation information through a network model, to obtain the second excitation information.

Optionally, in this embodiment of this application, the electronic device may obtain, by using a first algorithm, the second excitation information corresponding to the clean voice signal.

For example, the first algorithm may be a peak detection algorithm.

It may be understood that the electronic device may obtain the second excitation information by using an excitation codebook, or the electronic device may obtain the second excitation information without the excitation codebook, which may be specifically determined based on actual use. This is not limited in this embodiment of this application.
Step 203: The electronic device performs optimal envelope codebook matching on the first envelope information to obtain second envelope information.

In this embodiment of this application, the second envelope information is envelope information corresponding to the clean voice signal in the first voice signal.

In this embodiment of this application, the electronic device may perform optimal envelope codebook matching on the first envelope information through a network model, to obtain the second envelope information.

Optionally, in this embodiment of this application, the electronic device may obtain, by using a second algorithm, the second envelope information corresponding to the clean voice signal.

For example, the second algorithm may be a vector distance algorithm.

It may be understood that the electronic device may obtain the second envelope information by using an envelope codebook, or the electronic device may obtain the second envelope information without the envelope codebook, which may be specifically determined based on actual use. This is not limited in this embodiment of this application.
Step 204: The electronic device synthesizes target spectral information based on the first excitation information, the second excitation information, and the second envelope information.

In some embodiments of this application, the target spectral information is used to generate a target clean voice signal.

In some embodiments of this application, the electronic device may synthesize the target spectral information through linear predictive synthesis.

Optionally, in some embodiments of this application, the second envelope information includes gain information of a first vibration frequency corresponding to the first frequency domain signal; the second excitation information includes frequency information of the first vibration frequency; and the first excitation information includes frequency information of M vibration frequencies. The M vibration frequencies include the first vibration frequency, where M is a positive integer.

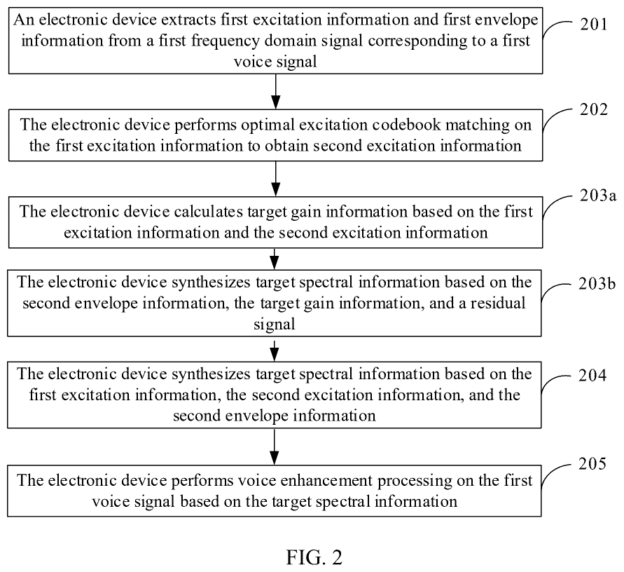

For example, with reference to FIG. 1, as shown in FIG. 2, the foregoing step 203 may be specifically implemented through the following step 203a and step 203b.
Step 203a: The electronic device calculates target gain information based on the first excitation information and the second excitation information.

In some embodiments of this application, the electronic device may transform the first excitation information and the second excitation information from cepstral domain into power spectral domain, and then calculate a difference to obtain the target gain information.

For example, the electronic device may obtain the target gain information by using the following Formula 7. Formula 7 may be specifically:

$${EG}_{res} ( f , k ) = FFT [ {E}_{s} ] - FFT [ {E}_{x} ] \qquad ( Formula 7 )$$

EGᵣₑₛ(f, k) represents the target gain information, Es represents the second excitation information, and Ex represents the first excitation information.
Step 203b: The electronic device synthesizes target spectral information based on the second envelope information, the target gain information, and a residual signal.

In some embodiments of this application, the residual signal is obtained by the electronic device performing linear filtering on the first frequency domain signal.

In some embodiments of this application, the electronic device may restore the second envelope information to an LPC linear prediction coefficient, and then synthesize the target spectral information based on the LPC linear prediction coefficient, the target gain information, and the residual signal.

For example, the electronic device may restore the second envelope information to the LPC linear prediction coefficient by using the following Formula 8. Formula 8 is specifically:

$$lpc \_α2 ( n ) = LSFtoLPC ( {A}_{s} ) \qquad ( Formula 8 )$$

lpc_α2 (n) represents the LPC linear prediction coefficient, and As represents the second envelope information.

For another example, the electronic device may synthesize the target spectral information based on the LPC linear prediction coefficient, the target gain information, and the residual signal by using the following Formula 9. Formula 9 is specifically:

$$\hat{S} ( f , k ) = \frac{{X}_{res} ( f , k ) \cdot {EG}_{res} ( f , k )}{1 - FFT [ lpc \_α2 ( n ) ]} \qquad ( Formula 9 )$$

Ŝ(f, k) represents the target spectral information, Xᵣₑₛ(f, k) represents the residual signal, EGᵣₑₛ(f, k) represents the target gain information, and lpc_α2(n) represents the LPC linear prediction coefficient.

In this embodiment of this application, the electronic device may obtain the target gain information by using the first excitation information and the second excitation information, and then synthesize the target spectral information by using the second envelope information, the target gain information, and the residual signal. It may be understood that because both the second excitation information and the second envelope information are information corresponding to the clean voice signal, the target spectral information obtained by the electronic device is also target spectral information corresponding to the clean voice signal. Further, the electronic device may, based on the target spectral information, perform voice enhancement processing on the first voice signal, to obtain a voice signal with a good noise reduction effect.
Step 205: The electronic device performs voice enhancement processing on the first voice signal based on the target spectral information.

In this embodiment of this application, the electronic device may calculate a prior signal-to-noise ratio based on the target spectral information and spectral information of noisy voice, estimate a noise power spectrum based on the prior signal-to-noise ratio, and further obtain a noise reduction gain based on the noise power spectrum.

It may be understood that the noise reduction gain is used for voice enhancement processing on the first voice signal.

For example, after the electronic device obtains the target spectral information Ŝ(f, k) and the spectral information X(f, k) of the noisy voice, the electronic device may separately calculate power spectral information Pₛₛ(f, k)=|Ŝ(f,k)|² of the target spectral information and power spectral information Pₓₓ(f,k)=|X(f,k)|² of the spectral information of the noisy voice, and calculate the prior signal-to-noise ratio, where the prior signal-to-noise ratio is ξ(f, k)=Pₛₛ(f,k)/Pₙₙ(f,k).

The electronic device may estimate the noise power spectrum through a statistical model in a conventional noise reduction method, which may be specifically implemented through the following Formula 10.

$${P}_{nn} ( f , k ) = \frac{ξ ( f , k - 1 )}{1 + ξ ( f , k - 1 )} \cdot {P}_{nn} ( f , k - 1 ) + {( \frac{1}{1 + ξ ( f , k - 1 )} )}^{2} \cdot {P}_{xx} ( f , k ) \qquad ( Formula 10 )$$

Pₙₙ(f, k) represents the noise power spectrum, ξ(f, k−1) represents a prior signal-to-noise ratio of a previous audio frame, Pₙₙ(f, k−1) represents a noise power spectrum of the previous audio frame, and Pₓₓ(f, k) represents power spectral information of the spectral information of the noisy voice.

Then, the electronic device calculates the noise reduction gain G(f, k) through MMSE estimation, which may be specifically implemented through the following Formula 11.

$${G}_{MMSE - LSA} ( f , k ) = \frac{ξ ( f , k )}{ξ ( f , k + 1 )} exp ( \frac{1}{2} {\int }_{vk}^{∞} \frac{{e}^{- t}}{t} dt ) \qquad ( Formula 11 )$$

$$vk = \frac{ξ ( f , k )}{ξ ( f , k ) + 1} γ ( f , k ) .$$

Finally, the electronic device may obtain a noise reduced signal spectrum by multiplying a spectrum of a noisy voice signal by the noise reduction gain, which may be specifically implemented through the following Formula 12.

$$S ( f , k ) = X ( f , k ) \cdot G ( f , k ) \qquad ( Formula 12 )$$

S(f, k) represents the noise reduced signal spectrum, G(f, k) represents the noise reduction gain, and X(f, k) represents the spectrum of the noisy voice signal.

Optionally, in some embodiments of this application, after the electronic device obtains the noise reduced signal spectrum, the electronic device may perform Fourier transform on the noise reduced signal spectrum, to obtain a noise reduced time domain signal, namely, the target clean voice signal.

In the voice enhancement method provided in this embodiment of this application, the electronic device may extract the first excitation information and the first envelope information from the first frequency domain signal corresponding to the first voice signal, where the first voice signal includes the noise signal and the first clean voice signal; then, the electronic device may perform optimal excitation codebook matching on the first excitation information to obtain the second excitation information, and perform optimal envelope codebook matching on the first envelope information to obtain the second envelope information; further, the electronic device may synthesize the target spectral information based on the first excitation information, the second excitation information, and the second envelope information; then, the electronic device may perform voice enhancement processing on the first voice signal based on the target spectral information. In this solution, the electronic device may perform optimal excitation codebook matching on the first excitation information, and perform optimal envelope codebook matching on the first envelope information. In this case, the electronic device may obtain the second excitation information and the second envelope information that correspond to the first clean voice signal, and can further obtain the target spectral information by using the first excitation information, the second excitation information, and the second envelope information, so that the electronic device may obtain, based on the target spectral information, an accurate prior signal-to-noise ratio corresponding to the first clean voice signal, and then the electronic device may perform voice enhancement processing based on the accurate prior signal-to-noise ratio. This improves a noise reduction effect of the electronic device for voice noise reduction.

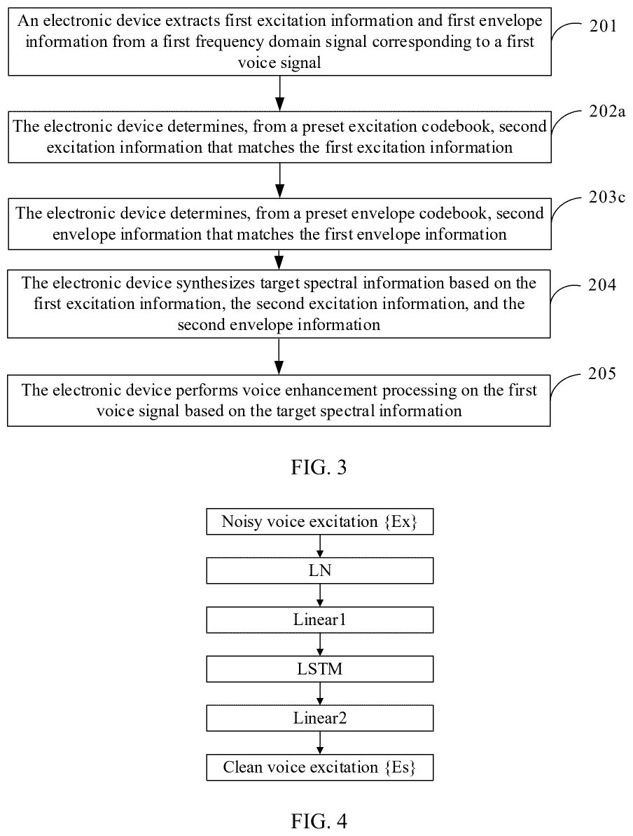

Optionally, in this embodiment of this application, with reference to FIG. 1, as shown in FIG. 3, the foregoing step 202 may be specifically implemented through the following step 202a. Alternatively, the foregoing step 203 may be specifically implemented through the following step 203c.
Step 202a: The electronic device determines, from a preset excitation codebook, the second excitation information that matches the first excitation information.

In this embodiment of this application, the preset excitation codebook is NC representative clean voice excitation information subsets obtained by training an excitation information set of clean voice signals.

It may be understood that the preset excitation codebook includes NC pieces of excitation information of the clean voice signal.

In this embodiment of this application, the electronic device may process each clean voice signal in a clean voice data set, to obtain the preset excitation codebook. The clean voice data set includes at least N clean voice signals, where N is a positive integer.

In this embodiment of this application, the preset excitation codebook includes a plurality of excitation codebooks, and each excitation codebook corresponds to one pitch period of the clean voice signal.

Optionally, in this embodiment of this application, the voice enhancement method provided in this embodiment of this application further includes the following step 301, and the foregoing step 202a may be specifically implemented through the following step 202al and step 202a2.
Step 301: The electronic device performs linear prediction analysis on the first frequency domain signal to obtain the first excitation information.

In this embodiment of this application, the electronic device may perform linear prediction analysis on the first frequency domain signal, to obtain a residual signal, where the residual signal corresponds to the first excitation information.

Optionally, in some embodiments of this application, before the electronic device extracts the first excitation information and the first envelope information from the first frequency domain signal corresponding to the first voice signal, the electronic device may perform pre-noise reduction processing on the first frequency domain signal. Then, the electronic device may obtain the first excitation information and the first envelope information based on the pre-noise reduced first frequency domain signal. In this case, the electronic device may extract the first excitation information and the first envelope information from the pre-noise reduced first frequency domain signal, so that the electronic device may obtain excitation information and envelope information that are closer to the clean voice signal.

For example, a first audio frame in the L audio frames corresponding to the first frequency domain signal is used as an example. When performing pre-noise reduction processing on a frequency domain signal corresponding to the first audio frame, the electronic device may, based on a noise reduction gain of a second audio frame, perform pre-noise reduction processing on the frequency domain signal corresponding to the first audio frame.

In this way, the electronic device may obtain, based on the frequency domain signal corresponding to the pre-noise reduced first audio frame, excitation information and envelope information that are closer to a clean frequency domain signal. It should be noted that the second audio frame is an audio frame that is immediately before the first audio frame.

For example, assuming that a frequency domain representation corresponding to the first audio frame is X(f, k), and the noise reduction gain of the second audio frame is G(f, k−1), the electronic device may perform pre-noise reduction processing on the first audio frame by using the following Formula 13. A formula is specifically:

$${X}_{c} ( f , k ) = X ( f , k ) \cdot G ( f , k - 1 ) \qquad ( Formula 13 )$$

X_{c}(f,k) represents a frequency domain representation corresponding to the noise reduced first audio frame, X(f, k) represents a frequency domain representation corresponding to a non-noise reduced first audio frame, and G(f, k−1) represents the noise reduction gain of the second audio frame.

It should be noted that in a case that the first audio frame is a 1^{st} audio frame in the L audio frames, the noise reduction gain of the second audio frame is preset.

It should be noted that, when performing pre-noise reduction processing on the first frequency domain signal, the electronic device performs pre-noise reduction processing on a frequency domain signal corresponding to each of the L audio frames. For a pre-noise reduction processing process of the frequency domain signal corresponding to each of the L audio frames, refer to the pre-noise reduction processing process of the frequency domain signal corresponding to the first audio frame. Details are not described herein again.

Optionally, in this embodiment of this application, the foregoing step 301 may be specifically implemented through the following step 301a and step 301b.
Step 301a: The electronic device performs linear prediction processing on the first frequency domain signal, to obtain a residual signal corresponding to the first frequency domain signal.

In this embodiment of this application, the electronic device may obtain, by using an autocorrelation coefficient corresponding to the first frequency domain signal, the residual signal corresponding to the first frequency domain signal.
Step 301b: The electronic device performs frequency domain transformation processing on the residual signal, to obtain a residual signal in cepstral domain.

In this embodiment of this application, the residual signal in cepstral domain is the first excitation information.

For example, the first audio frame in the L audio frames corresponding to the first frequency domain signal is used as an example. The electronic device may obtain, based on the frequency domain signal corresponding to the first audio frame, an autocorrelation coefficient corresponding to the first audio frame, then obtain a linear predictive coding (LPC) linear prediction coefficient based on the autocorrelation coefficient, then transform the LPC linear prediction coefficient into a frequency domain, and perform filtering processing to obtain a linear prediction residual signal, and transform the residual signal into cepstral domain, to obtain excitation information of the frequency domain signal corresponding to the first audio frame.

For example, the pre-noise reduced first audio frame is used as an example. The electronic device may obtain, by using an IFFT algorithm, the autocorrelation coefficient corresponding to the first audio frame, which may be specifically implemented through the following Formula 14.

$${R}_{a c c} ( n ) = IFFT [ {\vert {X}_{c} ( f , k ) \vert}^{2} ] \qquad ( Formula 14 )$$

R_{acc}(n) represents the autocorrelation coefficient corresponding to the pre-noise reduced first audio frame, and X_{c}(f,k) represents the frequency domain representation corresponding to the pre-noise reduced first audio frame.

The LPC linear prediction coefficient can be obtained through calculation by using the autocorrelation coefficient and a Levinson-Durbin recursion formula, which may be specifically implemented through the following Formula 15.

$$l p {c}_{-} α ( n ) = L e v i n s o n D u r b i n ( {R}_{a c c} ( n ) ) \qquad ( Formula 15 )$$

lpc_α(n) represents the LPC linear prediction coefficient.

The electronic device may transform the LPC linear prediction coefficient into the frequency domain, and perform filtering processing to obtain the linear prediction residual signal, which may be specifically implemented through the following Formula 16.

$${X}_{r e s} ( f , k ) = {X}_{c} ( f , k ) \cdot ( 1 - F F T [ l p {c}_{-} α ( n ) ] ) \qquad ( Formula 16 )$$

Xᵣₑₛ(f, k) represents the LPC residual signal.

It should be noted that, to avoid inclusion of time domain information in the LPC linear prediction coefficient, the electronic device may perform one frequency domain transformation on the LPC linear prediction coefficient, and transform the residual signal into cepstral domain, to obtain excitation information of the frequency domain signal corresponding to the pre-noise reduced first audio frame, which may be specifically implemented through the following Formula 17.

$${E}_{x} = IFFT [ 20 * log 10 ( \vert {X}_{r e s} ( f , k ) \vert ) ] \qquad ( Formula 17 )$$

Eₓ represents the excitation information of the frequency domain signal corresponding to the pre-noise reduced first audio frame.
Step 202a1: The electronic device determines a pitch period of the first frequency domain signal based on a peak value of the first excitation information.

In this embodiment of this application, there is an association relationship between the peak value and the pitch period. Therefore, after obtaining the peak value of the first excitation information, the electronic device may determine the pitch period of the first frequency domain signal based on the association relationship.

For example, the association relationship is preset by the electronic device or determined by a user.

Optionally, in this embodiment of this application, the first excitation information may include M pitch periods, and the M pitch periods respectively correspond to M pieces of excitation information in the first excitation information, where M is a positive integer.

For example, the correspondence may be a one-to-one relationship or a many-to-one relationship. That is, one pitch period corresponds to one piece of excitation information. Alternatively, one pitch period corresponds to K pieces of excitation information, where K is less than M.
Step 202a2: The electronic device determines, from the preset excitation codebook, the second excitation information corresponding to the pitch period.

In this embodiment of this application, the second excitation information is clean voice excitation information.

In this embodiment of this application, the electronic device determines a first pitch period of the first excitation information.

For example, the first voice signal carries mechanical wave energy, and a wavelength of this mechanical wave is referred to as a fundamental wave. A corresponding period of this fundamental wave is referred to as a pitch period.

Optionally, in this embodiment of this application, there may be one piece or a plurality of pieces of first excitation information.

In some embodiments of this application, after the electronic device obtains the first excitation information, the electronic device may search frequency values of the plurality of pieces of excitation information, and then obtain, by using a peak value of a frequency of the first excitation information, the first pitch period corresponding to the first excitation information.

In this embodiment of this application, the electronic device may use excitation information of a second clean voice signal in the preset excitation codebook as the second excitation information.

In this embodiment of this application, a pitch period corresponding to the second clean voice signal is the first pitch period.

In this embodiment of this application, the electronic device may find, in the preset excitation codebook, an excitation codebook that best matches the first pitch period, to obtain excitation information of a clean voice signal corresponding to the noisy voice signal, namely, the second excitation information.

For example, assuming that the first excitation information is a vector whose length is ½ of an FFT length, a pitch period F0 of a first audio signal may be determined by searching for a peak value location of a highest vibration frequency; and then a codebook that best matches the pitch period F0 is found from the preset excitation codebook by using the following Formula 18, to obtain the second excitation information. Formula 18 may be specifically:

$${E}_{s} = {E}_{c o d e b o o k} ( F 0 ) \qquad ( Formula 18 )$$

Eₛ represents the second excitation information, E_{codebook}( ) represents the preset excitation codebook, and F0 represents the pitch period of the first audio signal.

In this embodiment of this application, the electronic device may determine the second excitation information from the preset excitation codebook based on the pitch period of the first audio signal, so that the electronic device may estimate spectral information of the clean voice signal based on the second excitation information, thereby improving accuracy of the obtained spectral information by the electronic device.

Optionally, in this embodiment of this application, the foregoing step 202a may be specifically implemented through the following step 202a3.
Step 202a3: The electronic device inputs the first excitation information to a first network model, to obtain the second excitation information.

In this embodiment of this application, the first network model is an excitation matching model.

In this embodiment of this application, the excitation matching model may include the preset excitation codebook.

For example, the excitation matching model may be a first deep neural network model.

In this embodiment of this application, the electronic device may input the first excitation information to the first deep neural network model, to obtain the second excitation information.

For example, as shown in FIG. 4, the first deep neural network model may include a normalization layer (LayerNorm, LN) denoted by LN in FIG. 4, a first linear Layers denoted by Linear1 in FIG. 4, a long short-term memory (LSTM) layer denoted by LSTM in FIG. 4, and a second linear Layer denoted by Linear2 in FIG. 4.

For another example, the electronic device may input the first excitation information to the normalization layer, so that the electronic device may normalize the first excitation information, to obtain the normalized first excitation information. The electronic device inputs the normalized first excitation information to the first linear layer, and the first linear layer may perform feature extraction and dimensionality reduction processing on the normalized first excitation information, to output first feature information with a size of 128. Then, the electronic device performs time sequence modeling on the first feature information by using the LSTM layer, and the second linear layer is responsible for performing feature mapping on the modeled first feature information, output by the LSTM, and the preset excitation codebook in the first deep neural network model. In this case, the electronic device determines, from the preset excitation codebook, an excitation feature of the clean voice signal corresponding to the noisy voice signal, and outputs, by using the excitation feature, excitation information of the clean voice signal, namely, the second excitation information.

It should be noted that, the LSTM layer is a unidirectional LSTM network, and a quantity of layers is set to 2, so that hidden information of a time series is more fully explored; a quantity of hidden nodes of each of the two-layer LSTM layer is set to 128.

In some embodiments of this application, the electronic device may provide a deep neural network model that can directly predict the excitation information of the clean voice signal corresponding to the noisy voice signal, thereby avoiding interference caused by noise aliasing into the voice signal. An entire inference process of a neural network includes a process of restoring clean excitation information, resulting in a more accurate predicted value. Furthermore, the deep neural network model employs a sequence model with a time memory capability, and can resolve a long-distance dependency relationship in the voice signal, thereby better coping with complexity and a long delay of the voice signal.
Step 203c: The electronic device determines, from a preset envelope codebook, the second envelope information that matches the first envelope information.

In this embodiment of this application, the preset envelope codebook is NA representative clean voice envelope information subsets obtained by training an envelope information set of clean voice signals.

In some embodiments of this application, the electronic device may process the voice signal in the clean voice data set, to obtain the preset envelope codebook.

In this embodiment of this application, the electronic device uses envelope information of a third clean voice signal in the preset envelope codebook as the second envelope information.

In some embodiments of this application, the third clean voice signal is a clean voice signal that is in the preset envelope codebook and whose envelope information length has a smallest difference from a length of the first envelope information.

Optionally, in this embodiment of this application, the voice enhancement method provided in this embodiment of this application further includes the following step 401, and the foregoing step 203c may be specifically implemented through the following step 203c1.
Step 401: The electronic device performs linear prediction analysis on the first frequency domain signal to obtain the first envelope information.

In this embodiment of this application, the electronic device may obtain, by using the autocorrelation coefficient corresponding to the first frequency domain signal, a line spectral pair (LSF) corresponding to the first frequency domain signal, where the LSF corresponds to the first envelope information.

Optionally, in this embodiment of this application, the foregoing step 401 may be specifically implemented through the following step 401a and step 401b.
Step 401a: The electronic device performs linear prediction processing on the first frequency domain signal, to obtain a linear predictive coding coefficient corresponding to the first frequency domain signal.
Step 401b: The electronic device performs transformation processing on the linear predictive coding coefficient, to obtain a line spectral pair corresponding to the linear predictive coding coefficient.

In this embodiment of this application, the line spectral pair corresponding to the linear predictive coding coefficient is the first envelope information.

For example, the pre-noise reduced first audio frame is used as an example. The electronic device may obtain, by using an IFFT algorithm, the autocorrelation coefficient corresponding to the first audio frame, which may be specifically implemented through the foregoing Formula 14.

The LPC linear prediction coefficient can be obtained through calculation by using the autocorrelation coefficient and a Levinson-Durbin recursion formula, which may be specifically implemented through the foregoing Formula 15.

The LPC linear prediction coefficient is transformed into the LSF, to obtain envelope information of the frequency domain signal corresponding to the pre-noise reduced first audio frame, which may be specifically implemented through the following Formula 19.

$${A}_{x} = L P C t o L S F ( l p {c}_{-} α ( n ) ) \qquad ( Formula 19 )$$

Aₓ represents the envelope information of the frequency domain signal corresponding to the pre-noise reduced first audio frame.

It may be understood that the electronic device may process the frequency domain signal corresponding to each of the L audio frames according to the foregoing Formula 14 to Formula 19, to obtain excitation information and envelope information of a frequency domain signal corresponding to each audio frame.
Step 203cl: The electronic device determines, as the second envelope information, clean voice envelope information that is in the preset envelope codebook and that has a smallest vector distance to the first envelope information.

In this embodiment of this application, the electronic device may determine the second envelope information from the preset envelope codebook in a target manner.

Optionally, in this embodiment of this application, the target manner may include any one of following: Euclidean distance, cosine similarity, normalized Euclidean distance, Hamming distance, string similarity.

For example, assuming that the first envelope information is a vector whose length is P, in the preset envelope codebook, the electronic device may find an optimal match based on a minimum Euclidean distance of a vector, to obtain envelope information of the clean voice signal corresponding to the noisy voice signal, namely, the second envelope information, which may be specifically implemented through the following Formula 20.

$${A}_{s} = {A}_{c o d e b o o k} ( m ) ∀ m ∈ min \{ ‖ {A}_{x} - {A}_{c o d e b o o k} ( m ) ‖ \} \qquad ( Formula 20 )$$

Aₛ represents the second envelope information, A_{codebook}( ) represents the preset envelope codebook, and Aₓ represents the first envelope information.

In some embodiments of this application, the electronic device may obtain the second envelope information from the preset envelope codebook, so that the electronic device may estimate spectral information of the clean voice signal based on the second envelope information, thereby improving accuracy of the obtained spectral information by the electronic device.

Optionally, in this embodiment of this application, the foregoing step 203c may be specifically implemented through the following step 203a2.
Step 203c2: The electronic device inputs the first envelope information to a second network model, to obtain the second excitation information.

In this embodiment of this application, the second network model is an envelope matching model.

In this embodiment of this application, the second feature matching model includes the preset envelope codebook.

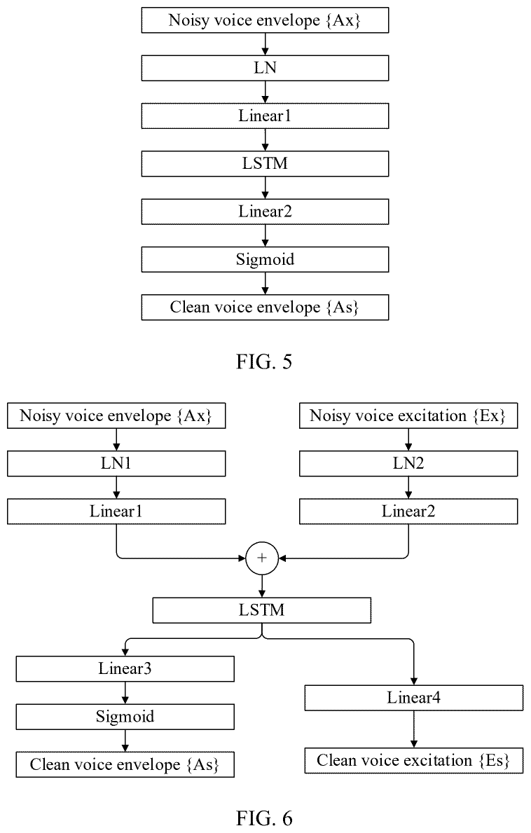

For example, as shown in FIG. 5, the second deep neural network model may include a normalization layer (LayerNorm, LN) denoted by LN in FIG. 5, a first linear Layers denoted by Linear1 in FIG. 5, a long short-term memory (LSTM) layer denoted by LSTM in FIG. 5, a second linear Layer denoted by Linear2 in FIG. 5, and an activation function(Sigmoid) layer denoted by Sigmoid in FIG. 5.

For another example, the activation function in the Sigmoid layer is σ(x)=−1/a+e^{-x}.

It should be noted that, the first envelope information is calculated by using the line spectral pair, and a value of the first envelope information is between 0 and 1. In the present invention, Simoid is selected as the activation function, and therefore, an obtained result is also between 0 and 1.

For another example, the electronic device may input the first envelope information to the normalization layer, so that the electronic device may normalize the first envelope information, to obtain the normalized first envelope information. The electronic device inputs the normalized first envelope information to the first linear layer, and the first linear layer may perform feature extraction and dimensionality reduction processing on the normalized first envelope information, to output second feature information with a size of P. Then, the electronic device performs time sequence modeling on the second feature information by using the LSTM layer, and the second linear layer is responsible for performing feature mapping on the modeled second feature information, output by the LSTM, and the preset envelope codebook in the second deep neural network model. Matching processing is performed on the modeled second feature information by using the activation function in the activation function layer, to obtain the second envelope information.

It should be noted that, the LSTM layer is a unidirectional LSTM network, and a quantity of layers is set to 2, so that hidden information of a time series is more fully explored; a quantity of hidden nodes of each of the two-layer LSTM layer is set to 128.

In some embodiments of this application, the electronic device provides a deep neural network model that can directly predict the envelope information of the clean voice signal, thereby avoiding interference caused by noise aliasing into the voice signal. An entire inference process of a neural network includes a process of restoring clean envelope information, resulting in a more accurate predicted value. Furthermore, the deep neural network model employs a sequence model with a time memory capability, and can resolve a long-distance dependency relationship in the voice signal, thereby better coping with complexity and a long delay of the voice signal.

Optionally, in this embodiment of this application, the foregoing step 202a and step 203a may be specifically implemented through the following step 501.
Step 501: The electronic device inputs the first excitation information and the first envelope information to a third network model, to obtain the second excitation information and the second envelope information.

In this embodiment of this application, the third network model is a cross-matching model.

In this embodiment of this application, the electronic device may input the first excitation information and the first envelope information to the third deep neural network, to simultaneously obtain the second excitation information and the second envelope information by using one deep neural network.

For example, the third deep neural network may include two branches. The two branches are a first branch and a second branch. The first branch is used to obtain the second envelope information, and the second branch is used to obtain the second excitation information.

For another example, as shown in FIG. 6, the first branch includes a first normalization layer denoted by LN1 in FIG. 6, and a first linear layer denoted by Linear1 in FIG. 6. The second branch includes a second normalization layer denoted by LN2 in FIG. 6, and a second linear layer denoted by Linear2 in FIG. 6. Then, the electronic device concatenates the feature information from the envelope information output by the first linear layer and the feature information from the excitation information output by the second linear layer by using a feature concatenation layer denoted by + in FIG. 6. Then, the electronic device inputs the concatenated feature information of the envelope information and the feature information of the excitation information, which are briefly referred to as fourth feature information, to the LSTM layer, performs time sequence modeling on the fourth feature information, and separately inputs the modeled fourth feature information to a third linear layer in the first branch denoted by Linear3 in FIG. 6 and a fourth linear layer in the second branch denoted by Linear4 in FIG. 6. Then, the electronic device obtains the second envelope information by using the activation function layer denoted by Sigmoid in FIG. 6 in the first branch, and the electronic device obtains the second excitation information by using the fourth linear layer in the second branch. In this way, the electronic device may separately predict envelope information of the clean voice signal and excitation information of the clean voice signal by using different branch networks.

In some embodiments of this application, the electronic device provides a deep neural network model that can directly predict an envelope feature of the clean voice signal and an excitation feature of the clean voice signal, thereby avoiding interference caused by noise aliasing into the voice signal. An entire inference process of a neural network includes a process of envelope restoration and excitation restoration, resulting in a more accurate predicted value. Furthermore, the deep neural network model employs a sequence model with a time memory capability, and can resolve a long-distance dependency relationship in the voice signal, thereby better coping with complexity and a long delay of the voice signal.

Optionally, in this embodiment of this application, the voice enhancement method provided in this embodiment of this application further includes the following step 501 to step 504.
Step 501: The electronic device obtains a clean voice signal set.

In this embodiment of this application, the clean voice signal set includes at least one clean voice signal.

Optionally, in this embodiment of this application, the clean voice signal set may be stored in the electronic device, or may be sent by another electronic device to the electronic device.
Step 502: The electronic device performs linear prediction processing on each clean voice signal in the clean voice signal set, to obtain a feature information set corresponding to the clean voice signal set.

In this embodiment of this application, the electronic device may obtain an LPC coefficient corresponding to each clean voice signal, and then obtain the feature information set based on the LPC coefficient.

In this embodiment of this application, the feature information set includes excitation information of the at least one clean voice signal.
Step 503: The electronic device performs peak detection on the feature information set, to obtain a pitch period corresponding to the feature information set.

In this embodiment of this application, the electronic device may perform peak detection on frequency information of all excitation information in the feature information set, to obtain a peak value corresponding to each piece of excitation information, and further obtain a pitch period corresponding to each piece of excitation information in the feature information set.
Step 504: The electronic device clusters feature information in the feature information set based on the pitch period, to obtain the preset excitation codebook.

For example, the electronic device may perform linear prediction analysis on each clean voice signal in the clean voice data set to obtain an LPC coefficient, perform linear filtering to obtain a residual signal, then perform a logarithmic operation on the residual signal and transform the residual signal into cepstral domain to obtain excitation information, and collect all excitation information, to obtain an excitation information set. Then, a peak value position of each piece of excitation information is determined by performing peak detection on each piece of excitation information in the excitation information set, where the peak value position corresponds to a pitch period F0 of the clean voice signal. The excitation information in the excitation information set is clustered based on F0. Excitation information with same F0 is grouped into a same cluster of excitation information. Weighted averaging is performed on the excitation information in the cluster, to obtain an excitation codebook of F0.

For example, the electronic device may perform weighted averaging on the same cluster of excitation information by using the following Formula 21, to obtain the excitation codebook of F0. The formula is specifically:

$${E}_{c o d e b o o k} ( f ) = \frac{1}{{N}_{c}} \sum {E}_{x} ( ∀ f == pitch ( {E}_{x} ) ) \qquad ( Formula 21 )$$

E_{codebook}(f) represents the preset excitation codebook, pitch (Eₓ) represents the same cluster of excitation information, and Eₓ represents any piece of excitation information of the same cluster of excitation information.

It may be understood that one pitch period corresponds to one excitation codebook, and the preset excitation codebook is an excitation codebook set corresponding to K pitch periods, where K is a positive integer.

It should be noted that an order of performing the foregoing step 501 to step 504 may be before the foregoing step 201 or before the foregoing step 202, and may be determined based on an actual use situation. This is not limited in this embodiment of this application.

In this embodiment of this application, because the preset excitation codebook includes excitation information of the clean voice signal, the electronic device may determine second excitation information from the preset excitation codebook, thereby ensuring that the electronic device may obtain target spectral information by using the excitation information of the clean voice signal, and further obtain a voice signal with a good noise reduction effect. Optionally, in this embodiment of this application, the voice enhancement method provided in this embodiment of this application further includes the following step 601 to step 603.
Step 601: The electronic device obtains a clean voice signal set.

In this embodiment of this application, the clean voice signal set includes at least one clean voice signal.

Optionally, in this embodiment of this application, the clean voice signal set may be stored in the electronic device, or may be sent by another electronic device to the electronic device.

Optionally, in this embodiment of this application, the clean voice signal set and the clean voice signal set in the foregoing step 501 may be a same voice signal set, or different voice signal sets.
Step 602: The electronic device performs linear prediction processing on each clean voice signal in the clean voice signal set, to obtain a feature information set corresponding to the clean voice signal set.

In this embodiment of this application, the electronic device may obtain an LPC coefficient corresponding to each clean voice signal, and then obtain the feature information set based on the LPC coefficient.

In this embodiment of this application, the feature information set includes envelope information of the at least one clean voice signal.
Step 603: The electronic device clusters the feature information set by using a preset algorithm, to obtain a preset envelope codebook.

For example, the electronic device may perform linear prediction analysis on the voice signal in the clean voice data set to obtain an LPC coefficient, transform the LPC coefficient into an LSF coefficient to function as envelope information, and collect all envelope information, to obtain an envelope information set. Then, the envelope information set is clustered by using an unsupervised machine learning method, to obtain a sparse representation of the preset envelope codebook.

It should be noted that, the electronic device clusters the envelope information set to obtain a clustering center of the envelope information set. The clustering center represents finding most representative envelope information in the envelope information set.

It should be noted that an order of performing the foregoing step 601 to step 603 may be before the foregoing step 201 or before the foregoing step 202, and may be determined based on an actual use situation. This is not limited in this embodiment of this application.

In this embodiment of this application, because the preset envelope codebook includes envelope information of the clean voice signal, the electronic device may determine second envelope information from the preset envelope codebook, thereby ensuring that the electronic device may obtain target spectral information by using the envelope information of the clean voice signal, and further obtain a voice signal with a good noise reduction effect.

For example, a method for determining spectral information provided in this embodiment of this application is explained and described by using specific embodiments. The method for determining spectral information provided in this embodiment of this application is explained and described on a per audio frame basis.
Step 20: An electronic device performs short-time Fourier transform on a first voice signal, to obtain a first frequency domain signal corresponding to the first voice signal.

In this embodiment of this application, the first frequency domain signal includes L audio frames.
Step 21: The electronic device performs pre-noise reduction and linear prediction analysis on a first audio frame, to obtain first excitation information and first envelope information of the first audio frame.

In this embodiment of this application, the first audio frame is any audio frame in the L audio frames.
Step 22: Perform excitation codebook matching.

In this embodiment of this application, the electronic device obtains, from a preset excitation codebook, second excitation information that matches the first excitation information.
Step 23: Perform envelope codebook matching.

In this embodiment of this application, the electronic device obtains, from a preset envelope codebook, second envelope information that matches the first envelope information.
Step 24: The electronic device obtains first spectral information based on an LPC linear prediction coefficient, the first excitation information, the second excitation information, and a residual signal.

In this embodiment of this application, the LPC linear prediction coefficient is obtained based on the second envelope information.
Step 25: The electronic device obtains a prior signal-to-noise ratio based on the first spectral information and spectral information of a noisy voice signal.
Step 26: The electronic device obtains a noise reduction gain based on the prior signal-to-noise ratio, and obtains, based on the noise reduction gain, a noise reduced signal spectrum.
Step 27: The electronic device performs STFT on the noise reduced signal spectrum to obtain a noise reduced time domain signal, namely, a target clean voice signal corresponding to the first audio frame.

It should be noted that, for specific implementations of the foregoing step 20 to step 27, refer to the foregoing embodiment. To avoid repetition, details are not described herein again.

In this embodiment of this application, the electronic device may perform optimal excitation codebook matching on the first excitation information, and perform optimal envelope codebook matching on the first envelope information. In this case, the electronic device may obtain the second excitation information and the second envelope information that correspond to the first clean voice signal, and further obtain the target spectral information by using the first excitation information, the second excitation information, and the second envelope information, so that the electronic device may obtain, based on the target spectral information, an accurate prior signal-to-noise ratio corresponding to the first clean voice signal, and then the electronic device may perform voice enhancement processing based on the accurate prior signal-to-noise ratio. This improves a noise reduction effect of the electronic device for voice noise reduction.

It should be noted that, the voice enhancement method provided in this embodiment of this application may be performed by a voice enhancement apparatus, an electronic device, or a functional module or entity in the electronic device. A voice enhancement apparatus provided in an embodiment of this application is described by using an example in which the voice enhancement apparatus performs a voice enhancement method according to an embodiment of this application.

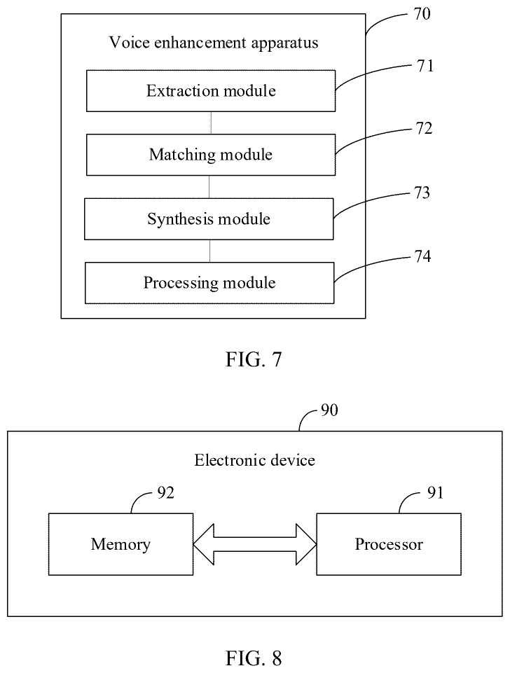

FIG. 7 is a possible schematic structural diagram of a voice enhancement apparatus according to an embodiment of this application. As shown in FIG. 7, the voice enhancement apparatus 70 may include: an extraction module 71, a matching module 72, a synthesis module 73, and a processing module 74.

The extraction module 71 is configured to extract first excitation information and first envelope information from a first frequency domain signal corresponding to a first voice signal, where the first voice signal includes a noise signal and a first clean voice signal. The matching module 72 is configured to: perform optimal excitation codebook matching on the first excitation information to obtain second excitation information, and perform optimal envelope codebook matching on the first envelope information to obtain second envelope information. The synthesis module 73 is configured to synthesize target spectral information based on the first excitation information, the second excitation information, and the second envelope information. The processing module 74 is configured to perform voice enhancement processing on the first voice signal based on the target spectral information.

In a possible implementation, the matching module 72 is specifically configured to: determine, from a preset excitation codebook, the second excitation information that matches the first excitation information; or determine, from a preset envelope codebook, the second envelope information that matches the first envelope information, where the preset excitation codebook is NC representative clean voice excitation information subsets obtained by training an excitation information set of clean voice signals; and the preset envelope codebook is NA representative clean voice excitation information subsets obtained by training an envelope information set of clean voice signals.

In a possible implementation, the processing module 74 is further configured to perform linear prediction analysis on the first frequency domain signal to obtain the first excitation information. The matching module 72 is specifically configured to: determine a pitch period of the first frequency domain signal based on a peak value of the first excitation information; and determine, from the preset excitation codebook, the second excitation information corresponding to the pitch period, where the second excitation information is clean voice excitation information.

In a possible implementation, the processing module 74 is specifically configured to: perform linear prediction processing on the first frequency domain signal, to obtain a residual signal corresponding to the first frequency domain signal; and perform frequency domain transformation processing on the residual signal, to obtain a residual signal in cepstral domain, where the residual signal in cepstral domain is the first excitation information.

In a possible implementation, the processing module 74 is further configured to perform linear prediction analysis on the first frequency domain signal to obtain the first envelope information. The matching module 72 is specifically configured to determine, as the second envelope information, clean voice envelope information that is in the preset envelope codebook and that has a smallest vector distance to the first envelope information.

In a possible implementation, the processing module 74 is specifically configured to: perform linear prediction processing on the first frequency domain signal, to obtain a linear predictive coding coefficient corresponding to the first frequency domain signal; and perform transformation processing on the linear predictive coding coefficient, to obtain a line spectral pair corresponding to the linear predictive coding coefficient, where the line spectral pair corresponding to the linear predictive coding coefficient is the first envelope information.

In a possible implementation, the voice enhancement apparatus provided in this embodiment of this application further includes an obtaining module. The obtaining module is configured to obtain a clean voice signal set, where the clean voice signal set includes at least one clean voice signal. The processing module 74 is further configured to: perform linear prediction processing on each clean voice signal in the clean voice signal set, to obtain a feature information set corresponding to the clean voice signal set; perform peak detection on the feature information set, to obtain a pitch period corresponding to the feature information set; and cluster feature information in the feature information set based on the pitch period, to obtain the preset excitation codebook.

In a possible implementation, the voice enhancement apparatus provided in this embodiment of this application further includes an obtaining module. The obtaining module is configured to obtain a clean voice signal set, where the clean voice signal set includes at least one clean voice signal. The processing module 74 is further configured to: perform linear prediction processing on each clean voice signal in the clean voice signal set, to obtain a feature information set corresponding to the clean voice signal set; and cluster the feature information set by using a preset algorithm, to obtain the preset envelope codebook.

In a possible implementation, the matching module 72 is specifically configured to input the first excitation information to a first network model, to obtain the second excitation information, where the first network model is an excitation matching model.

In a possible implementation, the matching module 72 is specifically configured to input the first envelope information to a second network model, to obtain the second excitation information, where the second network model is an envelope matching model.

In a possible implementation, the matching module 72 is specifically configured to input the first excitation information and the first envelope information to a third network model, to obtain the second excitation information and the second envelope information, where the third network model is a cross-matching model.

An embodiment of this application provides a voice enhancement apparatus. The voice enhancement apparatus may perform optimal excitation codebook matching on the first excitation information, and perform optimal envelope codebook matching on the first envelope information. In this case, the voice enhancement apparatus may obtain the second excitation information and the second envelope information that correspond to the first clean voice signal, and can further obtain the target spectral information by using the first excitation information, the second excitation information, and the second envelope information, so that the voice enhancement apparatus may obtain, based on the target spectral information, an accurate prior signal-to-noise ratio corresponding to the first clean voice signal, and then the voice enhancement apparatus may perform voice enhancement processing based on the accurate prior signal-to-noise ratio. This improves a noise reduction effect of the voice enhancement apparatus for voice noise reduction.

The voice enhancement apparatus in this embodiment of this application may be an electronic device, or may be a component such as a circuit or a chip in the electronic device. The electronic device may be a terminal, or another device other than the terminal. For example, the mobile electronic device may be a mobile phone, a tablet computer, a notebook computer, a palmtop computer, a vehicle-mounted electronic device, a mobile Internet device (MID), an augmented reality (AR)/virtual reality (VR) device, a robot, a wearable device, an ultra-mobile personal computer (UMPC), a netbook, a personal digital assistant (PDA), or the like. The mobile electronic device may be alternatively a server, a network attached storage (NAS), a personal computer (PC), a television(TV), a teller machine, a self-service machine, or the like. This is not specifically limited in this embodiment of this application.

The voice enhancement apparatus in this embodiment of this application may be an apparatus with an operating system. The operating system may be an Android operating system, an iOS operating system, or another possible operating system. This is not specifically limited in this embodiment of this application.

The voice enhancement apparatus provided in this embodiment of this application can implement the processes that are implemented in the foregoing method embodiments. To avoid repetition, details are not described herein again.

Optionally, as shown in FIG. 8, an embodiment of this application further provides an electronic device 90, including a processor 91 and a memory 92. The memory 92 stores a program or an instruction executable on the processor 91, and the program or the instruction is executed by the processor 91 to implement the steps of the foregoing embodiment of the method for determining spectral information, and same technical effects can be achieved. To avoid repetition, details are not described herein again.

It should be noted that the electronic device in this embodiment of this application includes the mobile electronic device and the non-mobile electronic device.

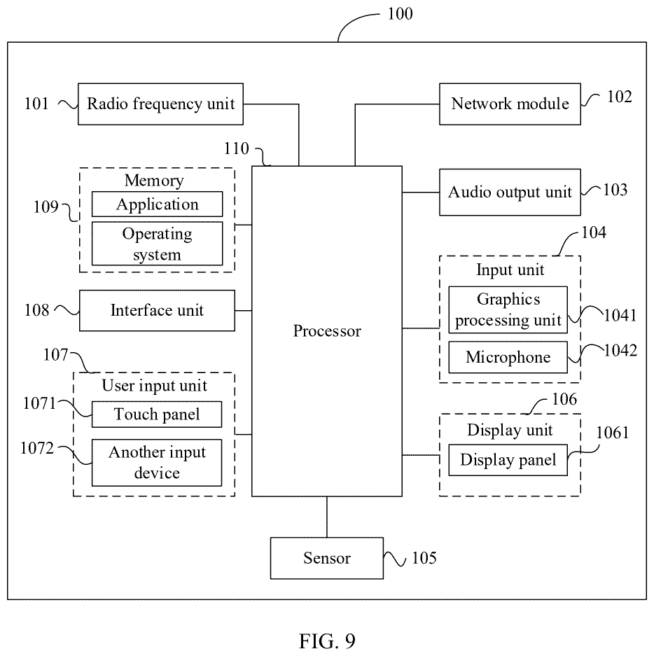

FIG. 9 is a schematic diagram of a hardware structure of an electronic device according to an embodiment of this application.

An electronic device 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the electronic device 100 may further include the power supply (for example, a battery) that supplies power to each component. The power supply may be logically connected to the processor 110 by using a power supply management system, to manage functions such as charging, discharging, and power consumption by using the power supply management system. The structure of the electronic device shown in FIG. 9 does not constitute a limitation on the electronic device, and the electronic device may include more or fewer components than those shown in the figure, or combine some components, or have different component arrangements. Details are not described herein again.

The processor 110 is configured to: extract first excitation information and first envelope information from a first frequency domain signal corresponding to a first voice signal, where the first voice signal includes a noise signal and a first clean voice signal; perform optimal excitation codebook matching on the first excitation information to obtain second excitation information; perform optimal envelope codebook matching on the first envelope information to obtain second envelope information; synthesize target spectral information based on the first excitation information, the second excitation information, and the second envelope information; and perform voice enhancement processing on the first voice signal based on the target spectral information.

An embodiment of this application provides the electronic device. The electronic device may perform optimal excitation codebook matching on the first excitation information, and perform optimal envelope codebook matching on the first envelope information. In this case, the electronic device may obtain the second excitation information and the second envelope information that correspond to the first clean voice signal, and further obtain the target spectral information by using the first excitation information, the second excitation information, and the second envelope information, so that the electronic device may obtain, based on the target spectral information, an accurate prior signal-to-noise ratio corresponding to the first clean voice signal, and then the electronic device may perform voice enhancement processing based on the accurate prior signal-to-noise ratio. This improves a noise reduction effect of the electronic device for voice noise reduction.

Optionally, in this embodiment of this application, the processor 110 is specifically configured to: determine, from a preset excitation codebook, the second excitation information that matches the first excitation information; or determine, from a preset envelope codebook, the second envelope information that matches the first envelope information, where the preset excitation codebook is NC representative clean voice excitation information subsets obtained by training an excitation information set of clean voice signals; and the preset envelope codebook is NA representative clean voice excitation information subsets obtained by training an envelope information set of clean voice signals.

Optionally, in this embodiment of this application, the processor 110 is further configured to: perform linear prediction analysis on the first frequency domain signal to obtain the first excitation information; determine a pitch period of the first frequency domain signal based on a peak value of the first excitation information; and determine, from the preset excitation codebook, the second excitation information corresponding to the pitch period, where the second excitation information is clean voice excitation information.

Optionally, in this embodiment of this application, the processor 110 is specifically configured to: perform linear prediction processing on the first frequency domain signal, to obtain a residual signal corresponding to the first frequency domain signal; and perform frequency domain transformation processing on the residual signal, to obtain a residual signal in cepstral domain, where the residual signal in cepstral domain is the first excitation information.

Optionally, in this embodiment of this application, the processor 110 is further configured to: perform linear prediction analysis on the first frequency domain signal to obtain the first envelope information; and determine, as the second envelope information, clean voice envelope information that is in the preset envelope codebook and that has a smallest vector distance to the first envelope information.

Optionally, in this embodiment of this application, the processor 110 is specifically configured to: perform linear prediction processing on the first frequency domain signal, to obtain a linear predictive coding coefficient corresponding to the first frequency domain signal; and perform transformation processing on the linear predictive coding coefficient, to obtain a line spectral pair corresponding to the linear predictive coding coefficient, where the line spectral pair corresponding to the linear predictive coding coefficient is the first envelope information.

Optionally, in this embodiment of this application, the processor 110 is further configured to: obtain a clean voice signal set, where the clean voice signal set includes at least one clean voice signal; perform linear prediction processing on each clean voice signal in the clean voice signal set, to obtain a feature information set corresponding to the clean voice signal set; perform peak detection on the feature information set, to obtain a pitch period corresponding to the feature information set; and cluster feature information in the feature information set based on the pitch period, to obtain the preset excitation codebook.

Optionally, in this embodiment of this application, the processor 110 is further configured to: obtain a clean voice signal set, where the clean voice signal set includes at least one clean voice signal; perform linear prediction processing on each clean voice signal in the clean voice signal set, to obtain a feature information set corresponding to the clean voice signal set; and cluster the feature information set by using a preset algorithm, to obtain the preset envelope codebook.

Optionally, in this embodiment of this application, the processor 110 is specifically configured to input the first excitation information to a first network model, to obtain the second excitation information, where the first network model is an excitation matching model.

Optionally, in this embodiment of this application, the processor 110 is specifically configured to input the first envelope information to a second network model, to obtain the second excitation information, where the second network model is an envelope matching model.

Optionally, in this embodiment of this application, the processor 110 is specifically configured to input the first excitation information and the first envelope information to a third network model, to obtain the second excitation information and the second envelope information, where the third network model is a cross-matching model.

The electronic device provided in this embodiment of this application can implement the processes of the foregoing method embodiments, with the same technical effects achieved. To avoid repetition, details are not described herein again.

For beneficial effects of the implementations in this embodiment, refer to the beneficial effects of the corresponding implementations in the foregoing method embodiment. To avoid repetition, details are not described herein again.

It should be understood that in this embodiment of this application, the input unit 104 may include a graphics processing unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

The memory 109 may be configured to store a software program and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 109 in this embodiment of this application includes but is not limited to these memories and any memory of another proper type.

The processor 110 may include one or more processing units. Optionally, an application processor and a modem processor are integrated into the processor 110. The application processor mainly processes an operating system, a user interface, an application, or the like. The modem processor mainly processes a wireless communication signal, for example, a baseband processor. It may be understood that, alternatively, the modem processor may not be integrated into the processor 110.

An embodiment of this application further provides a readable storage medium. The readable storage medium stores a program or an instruction, and the program or the instruction is executed by a processor to implement the processes of the foregoing method embodiment, and same technical effects can be achieved. To avoid repetition, details are not described herein again.

The processor is a processor in the electronic device in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing method embodiment, and same technical effects can be achieved. To avoid repetition, details are not described herein again.

It should be understood that the chip mentioned in this embodiment of this application may also be referred to as a system-level chip, a system chip, a chip system, or an on-chip system chip.

An embodiment of this application provides a computer program product. The program product is stored in a storage medium. The program product is executed by at least one processor to implement the processes of the foregoing embodiment of the method for determining spectral information, and same technical effects can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed order, and may further include performing functions in a basically simultaneous manner or in a reverse order according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, a network device, or the like) to perform the methods described in the embodiments of this application.

The embodiments of this application are described with reference to the accompanying drawings, but this application is not limited to the foregoing specific implementations, and the foregoing specific implementations are only illustrative and not restrictive.

1. A voice enhancement method, wherein the method comprises:
extracting first excitation information and first envelope information from a first frequency domain signal corresponding to a first voice signal, wherein the first voice signal comprises a noise signal and a first clean voice signal;
performing optimal excitation codebook matching on the first excitation information to obtain second excitation information;
performing optimal envelope codebook matching on the first envelope information to obtain second envelope information;
synthesizing target spectral information based on the first excitation information, the second excitation information, and the second envelope information; and
performing voice enhancement processing on the first voice signal based on the target spectral information.

2. The method according to claim 1, wherein the performing optimal excitation codebook matching on the first excitation information to obtain second excitation information comprises:
determining, from a preset excitation codebook, the second excitation information that matches the first excitation information; or
the performing optimal envelope codebook matching on the first envelope information to obtain second envelope information comprises:
determining, from a preset envelope codebook, the second envelope information that matches the first envelope information, wherein
the preset excitation codebook is NC representative clean voice excitation information subsets obtained by training an excitation information set of clean voice signals; and
the preset envelope codebook is NA representative clean voice envelope information subsets obtained by training an envelope information set of clean voice signals.

3. The method according to claim 2, wherein the method further comprises:
performing linear prediction analysis on the first frequency domain signal to obtain the first excitation information; and
the determining, from a preset excitation codebook, the second excitation information that matches the first excitation information comprises:
determining a pitch period of the first frequency domain signal based on a peak value of the first excitation information; and
determining, from the preset excitation codebook, the second excitation information corresponding to the pitch period, wherein the second excitation information is clean voice excitation information.

4. The method according to claim 3, wherein the performing linear prediction analysis on the first frequency domain signal to obtain the first excitation information comprises:
performing linear prediction processing on the first frequency domain signal, to obtain a residual signal corresponding to the first frequency domain signal; and
performing frequency domain transformation processing on the residual signal, to obtain a residual signal in cepstral domain, wherein
the residual signal in cepstral domain is the first excitation information.

5. The method according to claim 2, wherein the method further comprises:
performing linear prediction analysis on the first frequency domain signal to obtain the first envelope information; and
the determining, from a preset envelope codebook, the second envelope information that matches the first envelope information comprises:
determining, as the second envelope information, clean voice envelope information that is in the preset envelope codebook and that has a smallest vector distance to the first envelope information.

6. The method according to claim 5, wherein the performing linear prediction analysis on the first frequency domain signal to obtain the first envelope information comprises:
performing linear prediction processing on the first frequency domain signal, to obtain a linear predictive coding coefficient corresponding to the first frequency domain signal; and
performing transformation processing on the linear predictive coding coefficient, to obtain a line spectral pair corresponding to the linear predictive coding coefficient, wherein
the line spectral pair corresponding to the linear predictive coding coefficient is the first envelope information.

7. The method according to claim 2, wherein the method further comprises:
obtaining a clean voice signal set, wherein the clean voice signal set comprises at least one clean voice signal;
performing linear prediction processing on each clean voice signal in the clean voice signal set, to obtain a feature information set corresponding to the clean voice signal set;
performing peak detection on the feature information set, to obtain a pitch period corresponding to the feature information set; and
clustering feature information in the feature information set based on the pitch period, to obtain the preset excitation codebook.

8. The method according to claim 2, wherein the method further comprises:
obtaining a clean voice signal set, wherein the clean voice signal set comprises at least one clean voice signal;
performing linear prediction processing on each clean voice signal in the clean voice signal set, to obtain a feature information set corresponding to the clean voice signal set; and
clustering the feature information set by using a preset algorithm, to obtain the preset envelope codebook.

9. The method according to claim 1, wherein the performing optimal excitation codebook matching on the first excitation information to obtain second excitation information comprises:
inputting the first excitation information to a first network model, to obtain the second excitation information, wherein
the first network model is an excitation matching model.

10. The method according to claim 1, wherein the performing optimal envelope codebook matching on the first envelope information to obtain second envelope information comprises:
inputting the first envelope information to a second network model, to obtain the second excitation information, wherein
the second network model is an envelope matching model.

11. The method according to claim 1, wherein the performing optimal excitation codebook matching on the first excitation information to obtain second excitation information and performing optimal envelope codebook matching on the first envelope information to obtain second envelope information comprises:
inputting the first excitation information and the first envelope information to a third network model, to obtain the second excitation information and the second envelope information, wherein
the third network model is a cross-matching model.

12. An electronic device, comprising a processor, a memory, and a program or an instruction stored in the memory and executable on the processor, wherein the program or the instruction, when executed by the processor, causes the electronic device to perform:
extracting first excitation information and first envelope information from a first frequency domain signal corresponding to a first voice signal, wherein the first voice signal comprises a noise signal and a first clean voice signal;
performing optimal excitation codebook matching on the first excitation information to obtain second excitation information;
performing optimal envelope codebook matching on the first envelope information to obtain second envelope information;
synthesizing target spectral information based on the first excitation information, the second excitation information, and the second envelope information; and
performing voice enhancement processing on the first voice signal based on the target spectral information.

13. The electronic device according to claim 12, wherein when performing optimal excitation codebook matching on the first excitation information to obtain second excitation information, the program or the instruction, when executed by the processor, causes the electronic device to perform:
determining, from a preset excitation codebook, the second excitation information that matches the first excitation information; or
when performing optimal envelope codebook matching on the first envelope information to obtain second envelope information, the program or the instruction, when executed by the processor, causes the electronic device to perform:
determining, from a preset envelope codebook, the second envelope information that matches the first envelope information, wherein
the preset excitation codebook is NC representative clean voice excitation information subsets obtained by training an excitation information set of clean voice signals; and
the preset envelope codebook is NA representative clean voice envelope information subsets obtained by training an envelope information set of clean voice signals.

14. The electronic device according to claim 13, wherein the program or the instruction, when executed by the processor, causes the electronic device to further perform:
performing linear prediction analysis on the first frequency domain signal to obtain the first excitation information; and
when determining, from a preset excitation codebook, the second excitation information that matches the first excitation information, the program or the instruction, when executed by the processor, causes the electronic device to perform:
determining a pitch period of the first frequency domain signal based on a peak value of the first excitation information; and
determining, from the preset excitation codebook, the second excitation information corresponding to the pitch period, wherein the second excitation information is clean voice excitation information.

15. The electronic device according to claim 14, wherein when performing linear prediction analysis on the first frequency domain signal to obtain the first excitation information, the program or the instruction, when executed by the processor, causes the electronic device to perform:
performing linear prediction processing on the first frequency domain signal, to obtain a residual signal corresponding to the first frequency domain signal; and
performing frequency domain transformation processing on the residual signal, to obtain a residual signal in cepstral domain, wherein
the residual signal in cepstral domain is the first excitation information.

16. The electronic device according to claim 13, wherein the program or the instruction, when executed by the processor, causes the electronic device to further perform:
performing linear prediction analysis on the first frequency domain signal to obtain the first envelope information; and
when determining, from a preset envelope codebook, the second envelope information that matches the first envelope information, the program or the instruction, when executed by the processor, causes the electronic device to perform:
determining, as the second envelope information, clean voice envelope information that is in the preset envelope codebook and that has a smallest vector distance to the first envelope information.

17. The electronic device according to claim 16, wherein when performing linear prediction analysis on the first frequency domain signal to obtain the first envelope information, the program or the instruction, when executed by the processor, causes the electronic device to perform:
performing linear prediction processing on the first frequency domain signal, to obtain a linear predictive coding coefficient corresponding to the first frequency domain signal; and
performing transformation processing on the linear predictive coding coefficient, to obtain a line spectral pair corresponding to the linear predictive coding coefficient, wherein the line spectral pair corresponding to the linear predictive coding coefficient is the first envelope information.

18. The electronic device according to claim 13, wherein the program or the instruction, when executed by the processor, causes the electronic device to further perform:
obtaining a clean voice signal set, wherein the clean voice signal set comprises at least one clean voice signal;
performing linear prediction processing on each clean voice signal in the clean voice signal set, to obtain a feature information set corresponding to the clean voice signal set;
performing peak detection on the feature information set, to obtain a pitch period corresponding to the feature information set; and
clustering feature information in the feature information set based on the pitch period, to obtain the preset excitation codebook.

19. The electronic device according to claim 13, wherein the program or the instruction, when executed by the processor, causes the electronic device to further perform:
obtaining a clean voice signal set, wherein the clean voice signal set comprises at least one clean voice signal;
performing linear prediction processing on each clean voice signal in the clean voice signal set, to obtain a feature information set corresponding to the clean voice signal set; and
clustering the feature information set by using a preset algorithm, to obtain the preset envelope codebook.

20. A non-transitory readable storage medium, wherein the non-transitory readable storage medium stores a program or an instruction, wherein the program or the instruction, when executed by a processor of an electronic device, causes the electronic device to perform:
extracting first excitation information and first envelope information from a first frequency domain signal corresponding to a first voice signal, wherein the first voice signal comprises a noise signal and a first clean voice signal;
performing optimal excitation codebook matching on the first excitation information to obtain second excitation information;
performing optimal envelope codebook matching on the first envelope information to obtain second envelope information;
synthesizing target spectral information based on the first excitation information, the second excitation information, and the second envelope information; and
performing voice enhancement processing on the first voice signal based on the target spectral information.
